(19) United States
(12) Patent Application Publication
(10) Pub. No.: US 2025/0110466 A1
(43) Pub. Date: Apr. 3, 2025

(54) Method and Apparatus for Using Graphical Industrial Program Structures with a Language Model

(71) Applicant: Siemens Aktiengesellschaft, Muenchen (DE)

(72) Inventor: Martin WITTE, Schwabach (DE)

(21) Appl. No.: 18/898,868

(22) Filed: Sep. 27, 2024

(30) Foreign Application Priority Data
Sep. 28, 2023 (EP) 23200504

(51) Int. Cl. G05B 19/05

(52) U.S. Cl. CPC G05B 19/056; G05B 2219/13004; G05B 2219/13144

(57) ABSTRACT

A method and a programming device for using a system with artificial intelligence with a text-based language model, in particular a generative pretrained chatbot, for processing at least one graphical program construct with a plurality of program expressions in a graphical industrial programming language, in particular a coupling plan, wherein the graphical program expressions are converted into a sequence of Boolean program expressions in text form to input the graphical program construct into the system, where non-Boolean, in particular text-based, program expressions of the graphical program construct are each integrated between the adjacent Boolean program expressions such that language models can be used to learn and use structures of ladder diagram programs, in particular as tools for analyzing program constructs and for AI-based assistance in the creation and development of industrial software in automation technology.

### BACKGROUND OF THE INVENTION

### 1. Field of the Invention

The invention relates to a programming device and method for using a system with artificial intelligence with a text-based language model for processing at least one graphical program construct.

### 2. Description of the Related Art

Language models, such as those used in a chatbot with artificial intelligence called ChatGPT from OpenAI, require a text-based language for man-machine communication to function. Graphical languages are not directly accessible to them. Most automation engineers prefer graphical languages in accordance with European Norm (EN) 611131/International Electrotechnical Commission (IEC) 61131, in particular ladder diagrams (LDs). Therefore, ladder diagrams, sequential function charts (SFCs) and other graphical languages (for example, graphic for sequence control) cannot be generated or otherwise supported by language models.

There is no known solution for the use of language models in the field of graphical languages, in particular graphical programming languages for industrial automation components (for example, programmable logic controllers (PLCs)). However, such a solution is desirable because it would allow AI-based language models to be used, for example, to develop existing automation programs and thus to create or improve industrial control systems for the automation of production plants or in process industries, where moreover software developers can continue to work with languages and development tools familiar to them.

### SUMMARY OF THE INVENTION

Consequently, it is an object of the present invention to provide an apparatus and method for using constructs of graphic-based programming languages, in particular from industrial automation technology, for interaction with AI-based language models.

One solution of the problem requires the graphical language to be converted into a text format. The text format must have certain features in order to be interpretable:
It must be as compact and legible as possible.
It must not have any semantically unnecessary language components that have nothing to do with the domain (such as XML representations of LDs in engineering systems).
It must be understandable to humans so the result can be checked.
It must not contain any characters that are difficult to interpret.
It must be possible for textual representations to be converted back into the original graphical form.

These and other objects and advantages are achieved in accordance with the invention by a programming device and a method for using a system with artificial intelligence with a natural language text-based language model, in particular a generative pretrained chatbot, for processing at least one graphical program construct with a number of program expressions in a graphical industrial programming language, in particular a coupling plan. Here, during the course of inputting the graphical program construct into the system, the graphical program expressions are converted into a sequence of Boolean program expressions in text form, where non-Boolean (for example, text-based) program expressions of the graphical program construct are each integrated between the adjacent Boolean Program expressions. Thus, language models can be used to learn and use structures of ladder diagram programs, in particular as tools for analyzing program constructs and for AI-based assistance in the creation and development of industrial software in automation technology.

The objects and advantages are also achieved in accordance with the invention by a programming device for using a system with artificial intelligence with a natural language text-based language model, in particular a generative pretrained chatbot, for processing at least one graphical program construct with a plurality of program expressions in a graphical industrial programming language, in particular a coupling plan. Here, the programming device is configured via implementation software for executing the inventive method. This makes it possible to achieve the advantages already discussed with reference to the method.

The method can be used particularly advantageously if the graphical program construct is transmitted to the system with artificial intelligence not only for training, but also for generating a response message, where the response message then returns text-based program constructs, which are then used to program an industrial automation arrangement and thus to control industrial automation or an industrial process. For this purpose, a response program construct of the system consisting of text-based program expressions is advantageously converted into a graphical response program construct (“back conversion”) and this is used to program an industrial automation arrangement and to control an industrial process or industrial production.

In many practical applications, the non-Boolean text-based program expression of the graphical program construct is a function block with a plurality of input variables and/or a plurality of output variables. In the case of a plurality of non-Boolean input variables of the non-Boolean text-based program expression, these are advantageously defined as parameters in the generated text-based program construct and implemented as a link, preferably as a join. In the case of a plurality of non-Boolean output variables of the non-Boolean text-based program expression, these can be defined as output values in the generated text-based program construct and implemented as a branch, preferably as a fork or logical OR.

In an advantageous embodiment, the language model is pretrained with datasets with non-standardized function blocks, preferably with non-Boolean text-based program expressions. This enables the language model to be trained to process non-standardized syntax to appropriately extract it from the graphical program constructs. Furthermore, for the training, the non-Boolean input and/or output variables can each be advantageously designated with standard names to improve the extraction of these program expressions or elements.

For the back conversion of the text-based response program construct into the graphical response program construct, advantageously, an infix expression is converted into a postfix expression, where a stack-based conversion algorithm is used. Furthermore, during the back conversion, brackets and non-operators in front of brackets that cannot be represented in the graphical industrial programming language are advantageously removed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method according to the invention is explained below with reference to the drawings. At the same time, they also serve to explain an apparatus in accordance with the invention, i.e., a programming device, in which:

FIG. 1 shows the conversion of a graphical program construct into a Boolean expression (text form) in accordance with the invention;

FIG. 2 shows the conversion of a further program construct with an embedded function block into a compressed text form and then into an expanded text form in accordance with the invention; and

FIG. 3 shows the conversion of an infix expression into a postfix expression and then into a graphic and an LD annotation in accordance with the invention.

### DETAILED DESCRIPTION OF THE EXEMPLARY EMBODIMENTS

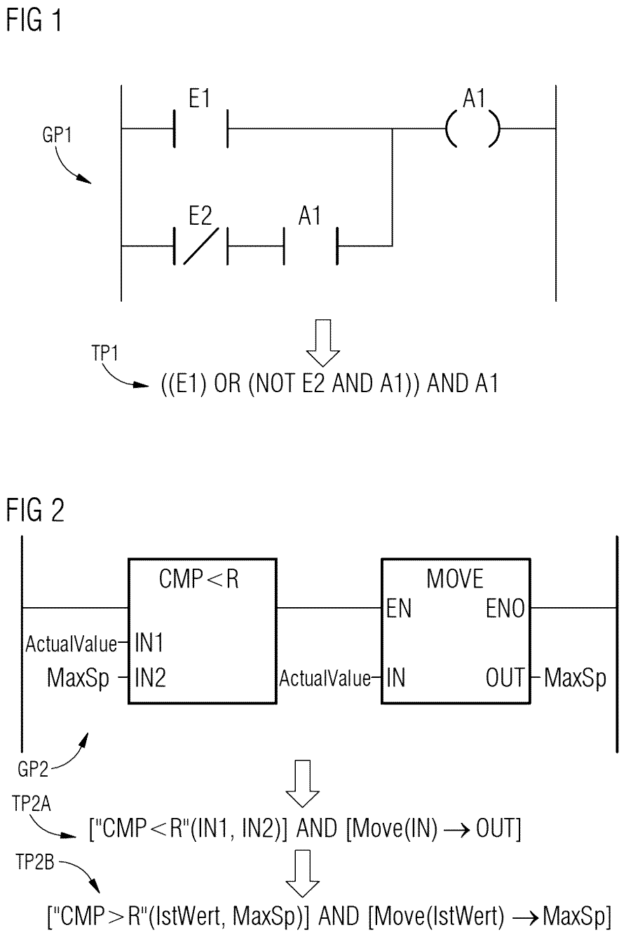

Mathematically, ladder diagrams and other graphical program constructs in the IEC 61131-3 standard are Boolean formulas represented as diagrams (see, for example, the graphical program construct GP1 at the top of FIG. 1). A sequence of objects connected by lines is a sequence of logical AND expressions. A branch is a non-exclusive OR of the branches thereof, starting with AND and an open square bracket. A link generates a closed bracket. Negation only exists for individual connections, not for a complete subgraphic. A virtual node that branches to the start lines is generated before all start lines (edges).

A plurality of different graphical program constructs (“LDs”; LD elements) is possible for one and the same formula (for example, Boolean expression), and conversely there is a plurality of formulas representing the same Boolean function. Therefore, the formula should be reduced to a canonical form, for example, by expanding it and thereby removing the brackets.

A node in the graphic is either a standard LD element (for example, flip-flop, negation) that can be converted directly into a Boolean expression and inserted into the formula or a function block with some Boolean inputs and outputs and other inputs and outputs, which are typically connected to data points (for example, registers or variables). Such function blocks (FBs) are also identified by a special character, for example [“TYPE_DATAPLACE_FB” ] for FBs with the name “TYPE_DATAPLACE_FB”.

The internals of such an FB are unknown (“black box”), and therefore two rules are applied: if a plurality of Boolean inputs is present, it functions as a “join” (a closed bracket is generated); if a plurality of outputs is available, it behaves like a “fork” (an OR is generated). The non-Boolean inputs are written as parameters of the function block (FB), the non-Boolean outputs with an output character, for example:
[“TYPE_DATAPLACE_FB” (x1, x2)□(y1, y2)].

If the language model is trained “against” an automation standard in which standard function blocks (“standard FBs”) are used, then the name for the FBs used should be as stated above. If the language model is trained on different datasets with non-standardized function blocks, then the function block names are reduced to a common name, for example “FB”. This reduces the language model to only learning the structure. If the (non-Boolean) input and output variables have a standard name, then this in turn restricts the language model to learning the structure instead of the specific scenario.

FIG. 1 shows a first example, where the graphical program construct GP1 (in the upper part) is converted into the text-based program construct TP1 (at the bottom).

When using function blocks (FBs), these program elements can be transferred to the text-based program construct TP2A, TP2B in the sense of a “black box” and treated by AI as a block with defined inputs and outputs. FIG. 2 shows this in a second example with a conversion of a comparison operation (“CMP”) and a conversion (“MOVE”), where the linked variables IN1, IN2 are resolved (expanded) (ActualValue, MaxSp) in the second conversion.

It should be noted that the second case is less generic and less useful for training language models, unless the variable names are standardized.

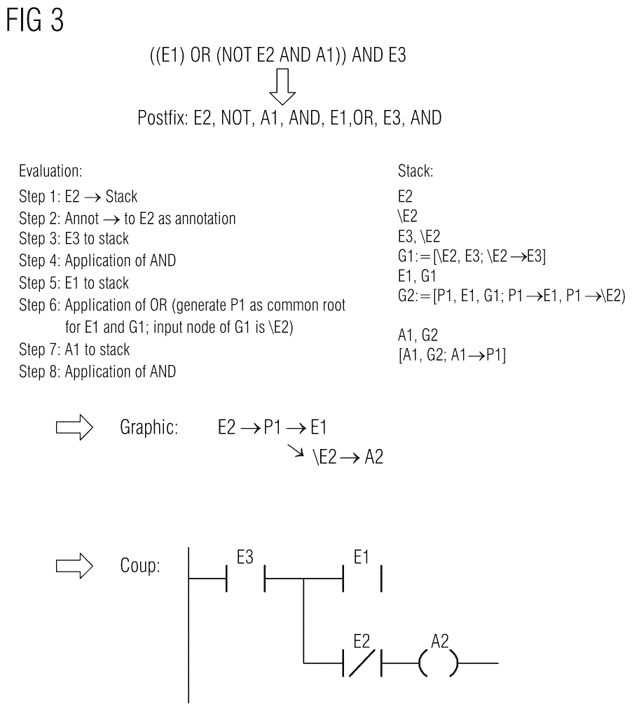

To convert a formula generated by the language engine back into a graphical expression or a graphical program construct (for example, LD), the infix expression (top of FIG. 3) is converted into a postfix expression using the known stack-based conversion algorithm. This removes the brackets and non-operators in front of brackets that cannot be represented in the LD (“ladder diagram”; coupling plan). Finally, the postfix is converted into an LD graphic. This is depicted in FIG. 3.

This gives a postfix expression (FIG. 3, 2^{nd} line) in which the entries are either
the operands that represent the input/output variables or a function block with the relevant Boolean input/output points, or
the operators (logical “AND”, “non-exclusive OR” and “negation” as a unitary operator).

The aim is to generate a directed graphic that represents the LD (“coupling plan”) (an LD is an acyclic directed graphic). An expression X->Y in each case denotes a direct connection from X to Y.

A stack (stack memory structure) that stores subgraphics is defined. As usual, the operands are taken from the left of the postfix expression. If the expression is an operand, then it is placed on the stack, herein it is interpreted as a subgraphic with only one node. If it is an operator, then it is applied to the uppermost elements (subgraphics) of the stack and the result, which is a new subgraphic, is placed on the stack. The subgraphic is generated as follows:
1. For an operator “AND”, the penultimate and last subgraphics of the stack are connected to a directed edge (line), wherein the penultimate subgraphic provides the output node and the last subgraphic provides the input node, which is unique due to the construction:
A
B
“AND”
becomes “b-->a” for b=end nodes of graphic B and a=start node of graphic A.
2. For an operator “OR”, a pseudo node is created that connects the top two graphics A and B of the stacks; the resulting graphic is stored on the stack:
A
B
“OR”
becomes

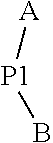

3. For an operator “Negation”, the top stack element is annotated as negated. The element is always a single node due to the construction.

It is not difficult to generate an LD from the directed graphic. The original nodes are connected on the left with the vertical start line of the LD. The graphic is then constructed to the right or downward in the direction of the edges. It should be noted that the edge direction describes the order in which the LD is evaluated. This is depicted at the bottom of FIG. 3.

Thus, language models can be used to learn structures of ladder diagram programs. The vocabulary is minimized and the detailing of the learned programs can be controlled by integrating or omitting function names and variable names. In principle, the method can be extended to signal flow-based programs, where any variables can be linked to the logic instead of Boolean expressions. In particular, language models can be used to learn and use structures of ladder diagram programs in a programming device for industrial automation components, in particular as tools for analyzing program constructs and for AI-based assistance in the creation and development of industrial software in automation technology.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for using a system with artificial intelligence with a text-based language model for processing at least one graphical program construct with a plurality of program expressions in a graphical industrial programming language, the method comprising:
converting graphical program expressions into a sequence of Boolean program expressions in text form to input the graphical program construct into the system; and
integrating non-Boolean program expressions of the graphical program construct between respective adjacent Boolean program expressions in the sequence.

2. The method as claimed in claim 1, wherein a response program construct of the system consisting of text-based program expressions is converted into a graphical response program construct and utilized to program an industrial automation arrangement and control an industrial process or industrial production.

3. The method as claimed in claim 1, wherein the non-Boolean text-based program expression of the graphical program construct is a function block with at least one of a plurality of input variables and a plurality of output variables.

4. The method as claimed in claim 2, wherein the non-Boolean text-based program expression of the graphical program construct is a function block with at least one of a plurality of input variables and a plurality of output variables.

5. The method as claimed in claim 3, wherein in cases of a plurality of non-Boolean input variables of the non-Boolean text-based program expression, these are defined as parameters in the generated text-based program construct and implemented as a link comprising a join.

6. The method as claimed in claim 3, wherein in cases of a plurality of non-Boolean output variables of the non-Boolean text-based program expression, these are defined as output values in the generated text-based program construct and implemented as one of (i) a branch comprising a fork and (ii) a logical OR.

7. The method as claimed in claim 5, wherein in cases of a plurality of non-Boolean output variables of the non-Boolean text-based program expression, these are defined as output values in the generated text-based program construct and implemented as one of (i) a branch comprising a fork and (ii) a logical OR.

8. The method as claimed in claim 1, wherein the language model is pretrained with datasets with non-standardized function blocks comprising non-Boolean text-based program expressions.

9. The method as claimed in claim 3, wherein at least one of (i) the non-Boolean input and (ii) output variables are each designated with standard names for the training.

10. The method as claimed in claim 2, wherein an infix expression is converted into a postfix expression to convert the text-based response program construct back into the graphical response program construct; and wherein a stack-based conversion algorithm is used.

11. The method as claimed in claim 10, wherein brackets and non-operators in front of brackets which cannot be represented in the graphical industrial programming language are removed during the back conversion.

12. The method as claimed in claim 1, wherein the text-based language model comprises a generative pretrained chatbot and the graphical industrial programming language comprises a coupling plan.

13. The method as claimed in claim 1, wherein non-Boolean program expressions are text-based.

14. A programming device for using a system with artificial intelligence with a natural language text-based language model for processing at least one graphical program construct with a plurality of program expressions in a graphical industrial programming language, the programming device via implementation software for executing the method as claimed in claim 1.

15. The programming device as claimed in claim 14, wherein the text-based language model comprises a generative pretrained chatbot and the graphical industrial programming language comprises a coupling plan.
